(19) United States
(12) Patent Application Publication
(10) Pub. No.: US 2017/0155417 A1
(43) Pub. Date: Jun. 1, 2017

(54) AMORPHOUS ALLOY-DEPOSITED CASE AND METHOD OF MANUFACTURING SAME

(71) Applicant: LG ELECTRONICS INC., Seoul (KR)

(72) Inventors: Daejin JEONG, Seoul (KR); Changshik MINN, Seoul (KR); Seokgyu KIM, Seoul (KR)

(73) Assignee: LG ELECTRONICS INC., Seoul (KR)

(21) Appl. No.: 15/324,573

(22) PCT Filed: Mar. 31, 2015
(86) PCT No.: PCT/KR2015/003149

§ 371 Date: Jan. 6, 2017

(30) Foreign Application Priority Data
Jul. 7, 2014 (KR) 10-2014-0084689
Mar. 9, 2015 (KR) 10-2015-0032524

(51) Int. Cl. H04B 1/3888

(52) U.S. Cl. CPC H04B 1/3888

(57) ABSTRACT

An amorphous alloy-deposited case includes: a molded article of a plastic or a metal material; and an amorphous alloy layer deposited on a top side of the molded article, and is characterized in that the thickness of the amorphous alloy layer ranges from 0.1 um to 2.5 um.

### TECHNICAL FIELD

The present disclosure relates to an amorphous alloy-deposited case and a method of manufacturing the same.

### BACKGROUND ART

In general, a case of a mobile device such as a smart phone, a tablet PC, and a laptop computer is made of a metal or a plastic material.

In the case of a plastic case, a metal material is sometimes deposited on a surface of the plastic case to realize a metal texture. In many cases, tin (Sn) is used for the metal material-deposited plastic case as a deposition material.

Meanwhile, since tin is easily oxidized and is difficult to be in close contact with a plastic side, the tin may be deposited on a surface of a plastic case through a method of forming a plurality of layers on the surface of the plastic case and interposing a tin layer between the plurality of layers.

When the tin layer is interposed between the plurality of layers formed on the surface of the plastic case as in the method, there are advantages of improving adhesion of the tin layer or preventing oxidation of the tin layer.

FIG. 1 is a cross-sectional view of a related art tin-deposited plastic case.

Referring to FIG. 1, a tin-deposited plastic case 10 may include: a case main body 11; a low degree or low level primer coating layer 12 located on a top side of the case main body 11; a tin-deposited layer 13 located on a top side of the primer coating layer 12; a middle degree or middle level coating layer 14 located on a top side of the tin-deposited layer 13; and a high degree or high level UV layer 15 located on a top side of the coating layer 14.

A metal texture on the surface of the case main body 11 may be provided to the tin-deposited plastic case 10, but an actual metal texture is hard to be felt as a user touches not a metal material but the high degree or high level UV layer 15 that is a polymer coating surface. In addition, since the plurality of layers including the primer coating layer 12, the coating layer 14, and the UV layer 15 are formed, there is a problem of thickening the coating side.

### DISCLOSURE OF INVENTION

### Technical Problem

Embodiments provide an amorphous alloy-deposited case and a method of manufacturing the same in which a user may feel a metal texture and also the thickness of a deposited layer may be reduced.

### Solution to Problem

In one embodiment, an amorphous alloy-deposited case according to an embodiment for achieving an above object includes: a molded article of a plastic or a metal material; and an amorphous alloy layer deposited on a top side of the molded article, and the thickness of the amorphous alloy layer ranges from 0.1 um to 2.5 um.

In another embodiment, a method of manufacturing an amorphous alloy-deposited case may include: cleaning a plastic molded article; and depositing an amorphous alloy material on a surface of the cleaned plastic molded article in a chamber filled with a mixture gas of an argon gas and a nitrogen gas.

### Advantageous Effects of Invention

According to a metal material-deposited case and a method of manufacturing the same according to the present invention, a user may feel not only a metal texture but also the metal itself.

Also, it is possible to make thin the deposition thickness of the case.

In addition, the deposition surface of the case has advantages of having a high strength and toughness.

### BRIEF DESCRIPTION OF DRAWINGS

FIG. 1 is a cross-sectional view of a related art tin-deposited plastic case.

FIG. 2 is a perspective view of a mobile device according to an embodiment.

FIG. 3 is a cross-sectional view illustrating a deposition layer of an amorphous alloy-deposited case of the mobile device of FIG. 2.

FIG. 4 is a cross-sectional view illustrating a deposition layer of an amorphous alloy-deposited case according to another embodiment.

FIG. 5 is a cross-sectional view illustrating a deposition layer of an amorphous alloy-deposited case according to further another embodiment.

FIG. 6 is a cross-sectional view illustrating an amorphous alloy layer-deposited figure, when irregularities are formed on a top side of a molded article of an amorphous alloy-deposited case.

FIG. 7 is a flow chart illustrating a method of manufacturing an amorphous alloy-deposited case according to further another embodiment.

### MODE FOR THE INVENTION

Reference will now be made in detail to the embodiments of the present disclosure, examples of which are illustrated in the accompanying drawings.

Hereinafter, with reference to drawings, an amorphous alloy-deposited case will be described according to an embodiment.

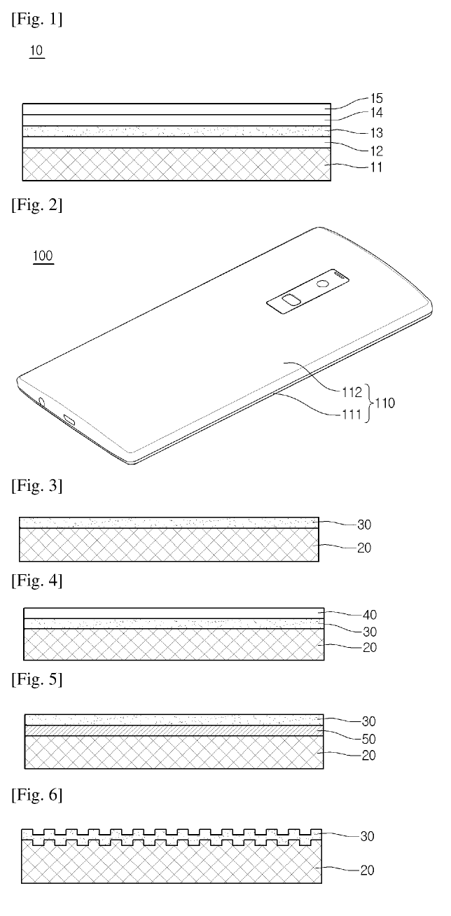

FIG. 2 is a perspective view of a mobile device according to an embodiment.

Referring to FIG. 2, a mobile device 100 according to an embodiment includes an amorphous alloy-deposited case 110 forming an exterior of the mobile device.

In detail, the amorphous alloy-deposited case 110 may include: a front case 111 in which a display panel is installed; a rear case (not shown) disposed on a rear surface of the front case 111; and a rear cover 112 covering a rear surface of the rear case (not shown). Here, the rear case (not shown) and the rear cover 112 may be integrally provided.

Various electronic components may be disposed in an interior space formed by a combination of the front case 111, the rear case (not shown), and the rear cover 112.

However, it is noted that the amorphous alloy-deposited case 110 is not limited to the case of the mobile device 100 illustrated FIG. 1 but may be applied to a case forming an exterior of a variety of electronic devices as well as a mobile device including a tablet PC, a laptop computer, and the like.

FIG. 3 is a cross-sectional view illustrating a deposition layer of an amorphous alloy-deposited case according to an embodiment.

Referring to FIG. 3, the amorphous alloy-deposited case 110 includes a molded article 20 and the amorphous alloy layer 30.

The molded article 20 may be manufactured by injecting a plastic material or by forging, pressing, or die-casting a metal material.

Hereinafter, the amorphous alloy layer 30 will be described with an example of a case in which the molded article 20 is made of a plastic material.

The amorphous alloy layer 30 is formed on a top side of the molded article 20 made of a plastic material. The amorphous alloy layer 30 with an amorphous structure which does not have a crystal structure has advantages of high hardness, strength, and toughness.

The amorphous alloy layer 30 may be deposited on a surface of the top side of the molded article 20 made of a plastic material by sputtering.

The thickness of the amorphous alloy layer 30 may be formed in a range of 0.1 um to 2.5 um. More specifically, the thickness of the amorphous alloy layer 30 preferably ranges from 0.1 um to 1 um.

When the thickness of the amorphous alloy layer 30 is less than 0.1 um, there are problems in that a user is difficult to feel the metal as well as a metal texture is hard to be realized in the molded article 20 made of a plastic material. In addition, there is a problem in that the amorphous alloy layer 30 is easily detached from the molded article 20.

On the other hand, when the thickness of the amorphous alloy layer 30 is 1 um or more, there are problems in that a partial crystallization may occur while the amorphous alloy layer 30 grows on the molded article 20 made of a plastic material by sputtering.

In more detail, when the thickness of the amorphous alloy layer 30 is 1 um or more, since a rapid cooling rate can not be maintained, a partial crystallization of the amorphous alloy layer 30 may proceed.

Here, even when the thickness of the amorphous alloy layer 30 is 1 um or more but 2.5 um or less, it is possible to form an amorphous alloy layer. However, when the thickness of the amorphous alloy layer 30 is more than 2.5 um, it is difficult to form an amorphous alloy layer as a crystallization occurs.

Since the amorphous alloy layer 30 exhibits brittleness when a portion of the amorphous alloy layer 30 is crystallized, there occur phenomena in which a surface of the amorphous alloy layer 30 is easily broken by an external impact and is corroded by moisture.

In addition, when the thickness of the amorphous alloy layer 30 is more than 1 um, shear deformation of the amorphous alloy layer 30 occurs. An external aesthetic sense may be maintained as a deformed part is softened in a process of the shear deformation of the amorphous alloy layer 30, but there occurs a problem in that adhesion to the surface of the molded article 20 having the deposited amorphous alloy layer 30 is reduced.

In summary, when the thickness of the amorphous alloy layer 30 ranges from 0.1 um to 1 um, a user may feel metal texture from the molded article 20 made of a plastic material and the amorphous alloy layer 30 having a pure amorphous structure may be formed on the molded article 20.

Meanwhile, the amorphous alloy layer 30 may be formed of zirconium Zr, aluminum Al or copper Cu. The amorphous alloy layer 30 may be formed of, but not limited to, an alloy containing one or more of titanium (Ti), nickel (Ni), chromium (Cr), silver (Ag), stainless steel (SUS), and indium (In).

When the amorphous alloy layer 30 is deposited on the molded article 20 made of a plastic material, an internal pressure of a vacuum chamber preferably ranges from 10⁻⁶ to 10⁻⁴ Pa and a surface temperature of the molded article 20 made of the plastic material preferably ranges from 30° C. to 100° C.

When the surface temperature of the molded article 20 made of the plastic material is lower than 30° C., the amorphous alloy layer 30 deposited on a top side of the molded article 20 may be easily exfoliated, and when a surface temperature of the molded article 20 is higher than 100° C., there is a problem in that durability of a article is degraded due to deformation of the plastic material.

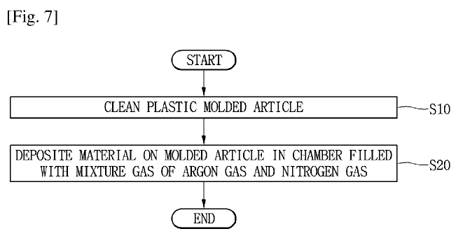

FIG. 4 is a cross-sectional view illustrating a deposition layer of an amorphous alloy-deposited case according to another embodiment.

Referring to FIG. 4, the amorphous alloy-deposited case 110 may further include a transparent coating layer 40. The transparent coating layer 40 is formed on a top side of the amorphous alloy layer 30.

The transparent coating layer 40 may be formed of a transparent metal material such as indium tin oxide (ITO), aluminum zinc oxide (AZO), or zinc oxide (ZnO), or a transparent ceramic material such as transparent alumina or transparent plomb lanthanum zirconate tanate (PLZT).

The thickness of the transparent coating layer 40 may range from 5 nm to 20 nm.

When the thickness of the transparent coating layer 40 is 20 nm or more, light transmittance is reduced to cause a problem in which a color sense of a metal in the amorphous alloy layer 30 is degraded. When the thickness of the transparent coating layer 40 is 5 nm or less, there occurs a problem in that a coating effect of the transparent coating layer 40 is degraded.

The transparent coating layer 40 may be formed of an UV coating layer.

An UV curable resin is sprayed on the top side of the amorphous alloy layer 30 and then is dried by using ultraviolet light (UV) to form the UV coating layer.

The transparent coating layer 40 may be formed of a transparent polymer material and may have a thickness ranging from 1.25 um to 5 um.

FIG. 5 is a cross-sectional view illustrating a deposition layer of an amorphous alloy-deposited case according to a further another embodiment.

Referring to FIG. 5, the amorphous alloy-deposited case 110 may further include a primer layer 50.

The primer layer 50 may be interposed between the molded article 20 and the amorphous alloy layer 30. The primer layer 50 enhances adhesion between the molded article 20 and the amorphous alloy layer 30.

The primer layer 50 may be formed of, but not limited to, low degree or low level epoxy polyester, low degree or low level epoxy-modified polyester, low degree or low level polyester for PCM, low degree or low level modified polyester for PCM or the like.

FIG. 6 is a cross-sectional view illustrating an amorphous alloy layer-deposited figure, when irregularities are formed on a top side of a molded article of an amorphous alloy-deposited case.

Referring to FIG. 6, the top side of the molded article 20 is formed with irregularities which can be defined as a convexoconcave portion or a convexoconcave surface. When the top side of the molded article 20 is formed with irregularities, a surface of the amorphous alloy layer 30 is also formed with irregularities to effectively realize a metal texture of the amorphous alloy-deposited case 110.

Meanwhile, the amorphous alloy-deposited case 110 may have an amorphous alloy layer 30 deposited on a molded article 20 made of a metal material. In this case, the thickness of the amorphous alloy layer 30 may range from 0.1 um to 2 um.

In summary, in the case of the amorphous alloy-deposited case 110, it is possible to make thin the coating layer by depositing only the amorphous alloy layer 30 on the molded article 20. In addition, a user may feel not only a metal texture but also the metal itself of the amorphous alloy layer 30.

Hereinafter, with reference to drawings, a method of manufacturing an amorphous alloy-deposited case will be described.

FIG. 7 is a flow chart illustrating a method of manufacturing an amorphous alloy-deposited case according to further another embodiment.

Referring to FIG. 7, a method of manufacturing an amorphous alloy-deposited case includes: cleaning a plastic molded article (S10); and depositing an amorphous alloy material on the cleaned plastic molded article in a chamber filled with a mixture gas of an argon gas and a nitrogen gas (S20).

Here, the nitrogen gas may enhance strength of the amorphous alloy layer 30 as well as change a color of the amorphous alloy layer 30 deposited on the surface of the plastic molded article 20.

The cleaning a plastic molded article (S10) may further include ionizing the surface of the plastic molded article.

An ion gun may be used to ionize the surface of the plastic molded article 20. When the plastic molded article 20 is ionized, adhesion between the molded article 20 and the amorphous alloy layer 30 is enhanced.

The method of manufacturing the amorphous alloy-deposited case may further include performing a primer coating on the surface of the cleaned plastic molded article.

The primer layer 50 enhances adhesion between the molded article 20 and the amorphous alloy layer 30.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An amorphous alloy-deposited case, comprising:
a molded article of a plastic or a metal material; and
an amorphous alloy layer deposited on a top side of the molded article, wherein the thickness of the amorphous alloy layer ranges from 0.1 um to 2.5 um.

2. The amorphous alloy-deposited case of claim 1, wherein the thickness of the amorphous alloy layer ranges from 0.1 um to 2 um.

3. The amorphous alloy-deposited case of claim 1, wherein the thickness of the amorphous alloy layer ranges from 0.1 um to 1 um.

4. The amorphous alloy-deposited case of claim 1, wherein the top side of the molded article is formed with irregularities, and the amorphous alloy layer is formed on the irregularities.

5. The amorphous alloy-deposited case of claim 1, wherein the amorphous alloy layer comprises zirconium (Zr), aluminum (Al) or copper (Cu).

6. The amorphous alloy-deposited case of claim 1, further comprising a transparent coating layer formed on the top side of the amorphous alloy layer.

7. The amorphous alloy-deposited case of claim 5, wherein the transparent coating layer is formed of a transparent metal material and has a thickness ranging from 5 nm to 20 nm.

8. The amorphous alloy-deposited case of claim 6, wherein the transparent metal material comprises indium tin oxide (ITO), aluminum zinc oxide (AZO), or zinc oxide (ZnO).

9. The amorphous alloy-deposited case of claim 5, wherein the transparent coating layer is formed of a transparent ceramic material and has a thickness ranging from 5 nm to 20 nm.

10. The amorphous alloy-deposited case of claim 8, wherein the transparent ceramic material comprises transparent alumina or transparent plomb lanthanum zirconate tanate (PLZT).

11. The amorphous alloy-deposited case of claim 5, wherein the transparent coating layer is formed of a transparent polymer material and has a thickness ranging from 1.25 um to 5 um.

12. The amorphous alloy-deposited case of claim 1, further comprising a primer layer interposed between the molded article, and the amorphous alloy layer.

13. A method of manufacturing an amorphous alloy-deposited case, the method comprising:
cleaning a plastic molded article; and
depositing an amorphous alloy material on a surface of the cleaned plastic molded article in a chamber filled with a mixture gas of an argon gas and a nitrogen gas.

14. The method of claim 12, wherein the cleaning a plastic molded article further comprises ionizing the surface of the plastic molded article.

15. The method of claim 13, further comprising performing a primer coating on the surface of the cleaned plastic molded article, wherein the amorphous alloy is deposited on the primer coating layer.

16. The method of claim 12, further comprising primer coating on the surface of the cleaned plastic molded article, wherein the amorphous alloy is deposited on the primer coating layer.

17. The amorphous alloy-deposited case of claim 2, wherein the top side of the molded article is formed with irregularities, and the amorphous alloy layer is formed on the irregularities.

18. The amorphous alloy-deposited case of claim 3, wherein the top side of the molded article is formed with irregularities, and the amorphous alloy layer is formed on the irregularities.
